(19) United States
(12) Patent Application Publication
(10) Pub. No.: US 2023/0125277 A1
(43) Pub. Date: Apr. 27, 2023

(54) INTEGRATION OF UPHOLES WITH INVERSION-BASED VELOCITY MODELING

(71) Applicant: Saudi Arabian Oil Company, Dhahran (SA)

(72) Inventors: Daniele Colombo, Dhahran (SA); Ersan Turkoglu, Dhahran (SA); Ernesto Sandoval-Curiel, Dhahran (SA); Diego Rovetta, Delft (NL); Apostolos Kontakis, Delft (NL); Weichang Li, Katy, TX (US)

(21) Appl. No.: 17/522,145

(22) Filed: Nov. 9, 2021

(30) Foreign Application Priority Data
Oct. 22, 2021 (GR) 20210100727

(51) Int. Cl. G01V 1/28; G01V 1/30; G06N 3/08; G06N 3/04

(52) U.S. Cl. CPC G01V 1/282; G01V 1/303; G06N 3/088; G06N 3/0454; G01V 2210/6222

(57) ABSTRACT

Disclosed are methods, systems, and computer-readable medium to perform operations including: receiving for a plurality of common midpoint-offset bins each comprising a respective plurality of seismic traces, respective candidate pilot traces representing the plurality of common midpoint-offset bins; generating, based on the respective candidate pilot traces, a respective plurality of corrected seismic traces for each of the plurality of common midpoint-offset bins; grouping the respective pluralities of corrected seismic traces into a plurality of enhanced virtual shot gathers (eVSGs); generating, based on the plurality of common midpoint-offset bins, a common-midpoint (CMP) velocity model; calibrating the CMP velocity model using uphole velocity data to generate a pseudo-3 dimensional (3D) velocity model; performing, based on the plurality of enhanced virtual shot gathers and the pseudo-3D velocity model, a 1.5-dimensional full waveform inversion (FWI); and determining the subsurface velocity model based on the 1.5 dimensional FWI.

### CROSS REFERENCE TO RELATED PATENT APPLICATIONS

This application claims the benefit of priority to Greek Application No. 20210100727 filed on Oct. 22, 2021.

### TECHNICAL FIELD

This specification relates generally to geophysical exploration, and more particularly to seismic surveying and processing of seismic data.

### BACKGROUND

In geology, sedimentary facies are bodies of sediment that are recognizably distinct from adjacent sediments that resulted from different depositional environments. Generally, geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays an important role in hydrocarbon exploration and is one key step in the interpretation of seismic data for reservoir characterization. The seismic facies in a given geological area can provide useful information, particularly about the types of sedimentary deposits and the anticipated lithology.

In reflection seismology, geologists and geophysicists perform seismic surveys to map and interpret sedimentary facies and other geologic features for applications including identification of potential petroleum reservoirs. Seismic surveys are conducted by using a controlled seismic source (for example, a seismic vibrator or dynamite) to create seismic waves. The seismic source is typically located at ground surface. Seismic body waves travel into the ground, are reflected by subsurface formations, and return to the surface where they recorded by sensors called geophones. Seismic surface waves travel along the ground surface and diminish as they get further from the surface. Seismic surface waves travel more slowly than seismic body waves. The geologists and geophysicists analyze the time it takes for the seismic body waves to reflect off subsurface formations and return to the surface to map sedimentary facies and other geologic features. Similarly, analysis of the time it takes seismic surface waves to travel from source to sensor can provide information about near surface features. This analysis can also incorporate data from sources, for example, borehole logging, gravity surveys, and magnetic surveys.

One approach to this analysis is based on tracing and correlating along continuous reflectors throughout the dataset produced by the seismic survey to produce structural maps that reflect the spatial variation in depth of certain facies. These maps can be used to identify impermeable layers and faults that can trap hydrocarbons such as oil and gas.

The seismic industry has experienced an increase in the number of seismic acquisition channels. The increased number of seismic acquisition channels has led to greater availability of data acquired in seismic surveys. However, conventional seismic data processing and analysis methods can be less useful for handling the increased amounts of data provided by modem seismic acquisition systems. For example, near surface analysis related to the increased size of the seismic datasets can pose challenges. Traditional methods for analysis of the subsurface domain, based on interactive procedures where input of an analyst is required can require time-consuming human intervention for quality control of the data.

### SUMMARY

The present disclosure is directed towards methods, systems, apparatus, computer programs, or combinations thereof, for performing 1.5 dimensional (1.5D) full waveform inversion (FWI) to build high resolution velocity models to improve the accuracy of seismic imaging of a subterranean formation.

In accordance with one aspect of the present disclosure, a method for generating a subsurface velocity model to improve an accuracy of seismic imaging of a subterranean formation is disclosed. The method involves receiving for a plurality of common midpoint-offset bins each including a respective plurality of seismic traces, respective candidate pilot traces representing the plurality of common midpoint-offset bins; generating, based on the respective candidate pilot traces, a respective plurality of corrected seismic traces for each of the plurality of common midpoint-offset bins; grouping the respective pluralities of corrected seismic traces into a plurality of enhanced virtual shot gathers (eVSGs); generating, based on the plurality of common midpoint-offset bins, a common-midpoint (CMP) velocity model; calibrating the CMP velocity model using uphole velocity data to generate a pseudo-3 dimensional (3D) velocity model; performing, based on the plurality of enhanced virtual shot gathers and the pseudo-3D velocity model, a 1.5-dimensional full waveform inversion (FWI); and determining the subsurface velocity model based on the 1.5 dimensional FWI.

Other versions include corresponding systems, apparatus, and computer programs to perform the actions of methods defined by instructions encoded on computer readable storage devices. These and other versions may optionally include one or more of the following features.

In some implementations, the method further involves pre-processing the uphole velocity data by: performing cubic Hermite spline fitting on the uphole velocity data to generate spline fitted velocity data; iteratively simplifying the spline fitted velocity data using a Douglas-Peucker method; and interpolating the simplified velocity data to generate an interval uphole velocity model.

In some implementations, calibrating the CMP velocity model using the uphole velocity data involves interpolating the uphole velocity data using a regionalized parameter distribution based on the CMP velocity model.

In some implementations, interpolating the uphole velocity data using the regionalized parameter distribution is performed using at least one of kriging, co-kriging, or a machine learning module.

In some implementations, interpolating the uphole velocity data is further performed using at least one of near-surface transmission residual statics or near-surface transmission amplitude residuals, where the near surface transmission residual statics and the near-surface transmission amplitude residuals are generated based on the respective pluralities of corrected seismic traces.

In some implementations, the method further involves generating, based on the pseudo-3D velocity model, gradient-based coupling operators; and applying the gradient-based coupling operators to constrain a 3D tomography process to generate a 3D velocity model calibrated with upholes.

In some implementations, performing the 1.5-dimensional full waveform inversion is further based on the 3D velocity model calibrated with upholes.

In some implementations, the method further involves calibrating the subsurface velocity model using a machine learning module, where the machine learning module is a conditional image to image mapping network, where the subsurface velocity model is an input to the machine learning module, and the uphole velocity and a distribution of CMP velocity are conditional inputs.

In some implementations, the method further involves calibrating the subsurface velocity model using a machine learning module, where the machine learning module is a semi-supervised Generative adversarial networks (GAN) framework.

The details of one or more implementations of the subject matter described in this disclosure are set forth in the accompanying drawings and the description. Other features, aspects, and advantages of the subject matter will become apparent from the description, the drawings, and the claims.

### BRIEF DESCRIPTION OF THE DRAWINGS

FIG. 1A is a schematic view of a seismic survey being performed to map subterranean features such as facies and faults, according to some implementations of the present disclosure.

FIG. 1B illustrates incident and reflected rays at a common midpoint (CMP) position compared to refracted ray paths, according to some implementations of the present disclosure.

FIG. 2 illustrates a three-dimensional cube representing a subterranean formation, according to some implementations of the present disclosure.

FIG. 3 illustrates a stratigraphic trace within the three-dimensional cube of FIG. 2, according to some implementations of the present disclosure.

FIG. 4 illustrates a flowchart that describes phases for generating uphole-calibrated near-surface velocities and preserving the uphole-calibrated near-surface velocities through an inversion-based velocity model building process, according to some implementations of the present disclosure.

FIG. 5 illustrates a workflow for automatic data enhancement for Full Waveform Inversion (FWI) in the midpoint-offset domain, according to some implementations of the present disclosure.

FIG. 6 illustrates a workflow that introduces a “geostatistics module” that integrates a shallow common midpoint (CMP) velocity model with uphole velocities, according to some implementations of the present disclosure.

FIG. 7 illustrates a workflow that uses multiple near-surface related features to guide the uphole-calibrated near-surface velocity model, according to some implementations of the present disclosure.

FIG. 8 illustrates a workflow that specifies a pre-processing module for uphole interpretation, according to some implementations of the present disclosure.

FIG. 9A illustrates conditional image-to-image mapping network, according to some implementations of the present disclosure.

FIG. 9B illustrates a generative adversarial network framework, according to some implementations of the present disclosure.

FIG. 10 is a diagram of an example computer system, according to some implementations of the present disclosure.

### DETAILED DESCRIPTION

This specification describes workflows for, but is not limited to, performing 1.5 dimensional (1.5D) full waveform inversion (FWI) to build high resolution velocity models to improve the accuracy of seismic imaging of a subterranean formation. It is presented to enable any person skilled in the art to make and use the disclosed subject matter in the context of one or more particular implementations. Various modifications, alterations, and permutations of the disclosed implementations can be made and will be readily apparent to those skilled in the art, and the general principles defined may be applied to other implementations and applications without departing from the scope of the disclosure. Thus, the present disclosure is not intended to be limited to the described or illustrated implementations, but is to be accorded the widest scope consistent with the principles and features disclosed.

This disclosure describes systems and methods for integrating upholes with inversion-based velocity modeling. The disclosed systems and methods involve generating enhanced virtual shot gathers (eVSG), performing full waveform inversion (FWI), normal moveout correction (NMO), velocity picking, common midpoint gather (CMP) stacking, and time or depth imaging. Note that the disclosed systems and methods include aspects of processes described in application Ser. No. 16/748,038, filed on Jan. 21, 2020, U.S. Pat. No. 10,067,255, filed on Sep. 4, 2015, U.S. Pat. No. 10,386,519, filed on Nov. 28, 2016, and U.S. Pat. No. 10,852,450, filed on May 3, 2017, application Ser. No. 17/121,044, filed on Dec. 14, 2020, and application Ser. No. 17/237,746, filed on Apr. 22, 2021, the contents of each of which are hereby incorporated by reference in entirety.

### I. Overview

Accurate and calibrated near surface velocity models are needed to perform reliable time-to-depth conversions of seismic images or seismic volumes. Upholes refer to shallow boreholes drilled to perform one-way travel time measurements to a seismic receiver (for example, a geophone) that is incrementally lowered at increasing depths within the borehole or vice versa a seismic source in the borehole recorded by surface geophones. The vertical travel time recordings at different depths provide the velocity profile of the near surface at a scale comparable to the propagation of seismic waves. Such local velocity profiles provide calibration to other data-driven velocity modeling methods, such as travel time tomography and full waveform inversion (FWI), which operate on large datasets and large areas, e.g., on the order of terabytes and thousands of square kilometers, respectively.

It is desirable for large area inversion-driven velocities to be calibrated by local uphole velocity measurements. However, implementing such a velocity calibration/integration scheme is challenging. Specifically, various problems arise that lead to unsatisfactory velocity calibration results that are ultimately not useful for the designated purpose. Some problems arise from the necessity of integrating shallow velocity measurements at a fine vertical scale and at sparse locations (upholes) with lower vertical resolution but also at spatially continuous velocity determinations from inversion methods (for example, tomography and FWI). The discrepancy in scale, resolution, and spatial distribution makes the integration step difficult to achieve.

One approach for the integration step is to apply geostatistical tools (for example, kriging or co-kriging) that allow spatial interpolation of upholes using spatial correlations from secondary-data control points and from the primary attribute to be estimated (for example, velocity). Co-kriging methods are used to take advantage of the covariance between two or more regionalized variables that are related. Specifically, co-kriging methods are appropriate when the main attribute of interest (for example, well data or uphole data) is sparse, but related secondary information is more abundant. The secondary information can be provided by an attribute that is correlated to the primary parameter to be interpolated. By using a cross-covariance model (for example, co-kriging) or the correlation coefficient (for example, collocated co-kriging), the influence of the secondary data on the primary data estimates can be calibrated and controlled. Such geostatistical techniques are used for geomodeling purposes for populating reservoir models using well log data or core analysis data as a primary variable and seismic impedance or other seismic attributes as a secondary variable. These techniques yield more-reliable reservoir models because they capitalize on the strengths of both data types.

For the near-surface problem, however, such geostatistical techniques are more difficult to apply for at least the following reasons. First, upholes are typically sparse compared to the size of the seismic blocks. Second, upholes are shallow relative to the depth section of the velocity model needed for seismic processing. Third, the secondary variable to be used for co-kriging is not well defined or is affected by noise or artifacts. Fourth, the secondary variable to be used may not be correlated with the primary variable. Fifth, the deeper portion of the velocity model needs to be derived through data-driven approaches while the shallow model with upholes needs to be preserved. The combination of these reasons make the geostatistical method to be of cumbersome application in real-case scenarios and a process that is closer to theory than to robust and repeatable data-driven automation.

Existing approaches have attempted to address the uphole integration problem. These approaches include: (i) building a velocity model combining uphole and refraction data using a “delay time stripping” method, (ii) co-kriging shallow uphole data with satellite images and vibrator plate attributes, and (iii) utilizing vibrator dynamic data through “vibrator attribute leading velocity estimation” (VALVE). However, these approaches only provide partial solutions to the problem with unsatisfactory results and lack generalization, automation, and repeatability.

Disclosed herein are methods and systems that solve the problem of integrating uphole and inversion-based methods in a repeatable and automated scheme. The methods and systems span the domains of multi-physics integration through joint inversion and machine learning/deep learning.

More specifically, this disclosure describes the primary operational challenges for integrating upholes with FWI (or other inversion-based methods) and describes workflows for solving each the challenges. One aspect is related to interpolation/extrapolation of calibrated uphole velocities to the near surface volume. Another aspect relates to implementing the interpolation/extrapolation of the localized uphole velocity. Yet another aspect relates to the preservation of the obtained uphole-calibrated shallow velocities in the framework of a large-scale inversion. The disclosed invention updates velocities and, simultaneously, preserves the structure and calibrations provided by the uphole interpolation/extrapolation guided by the external regionalized properties. These workflows can be performed with minimal or no user input required.

### II. Seismic Surveys

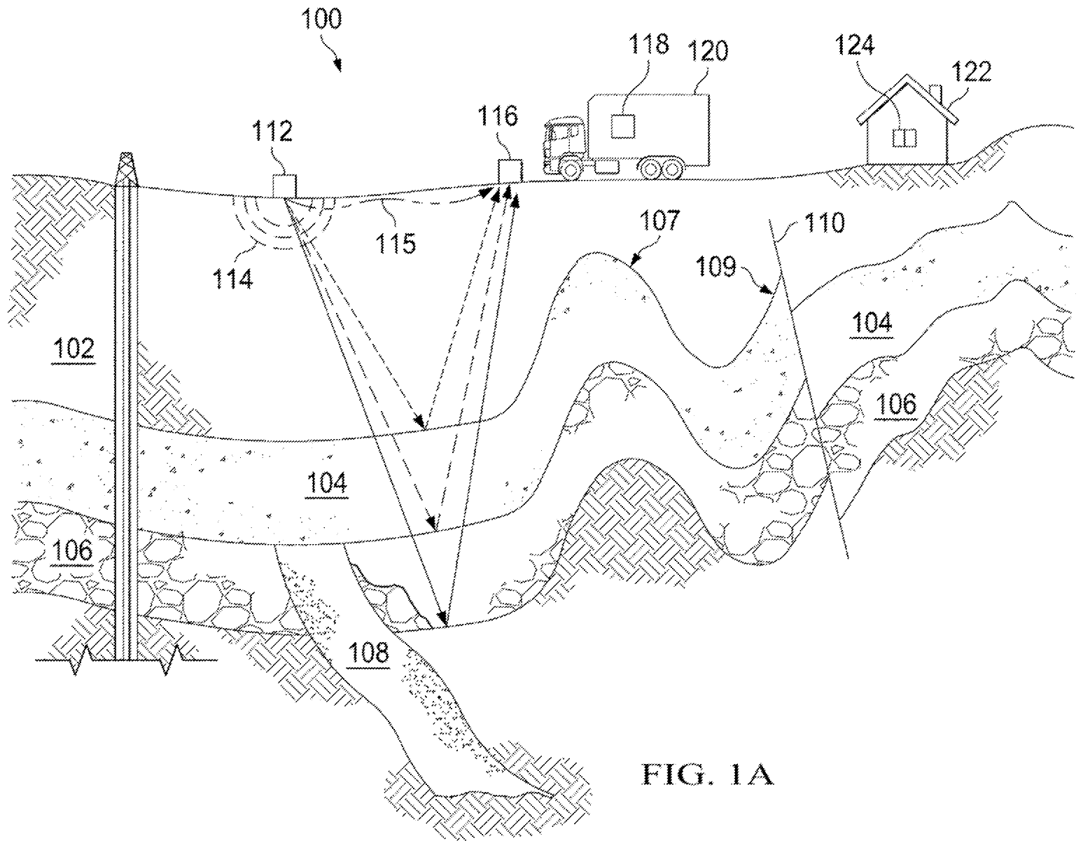

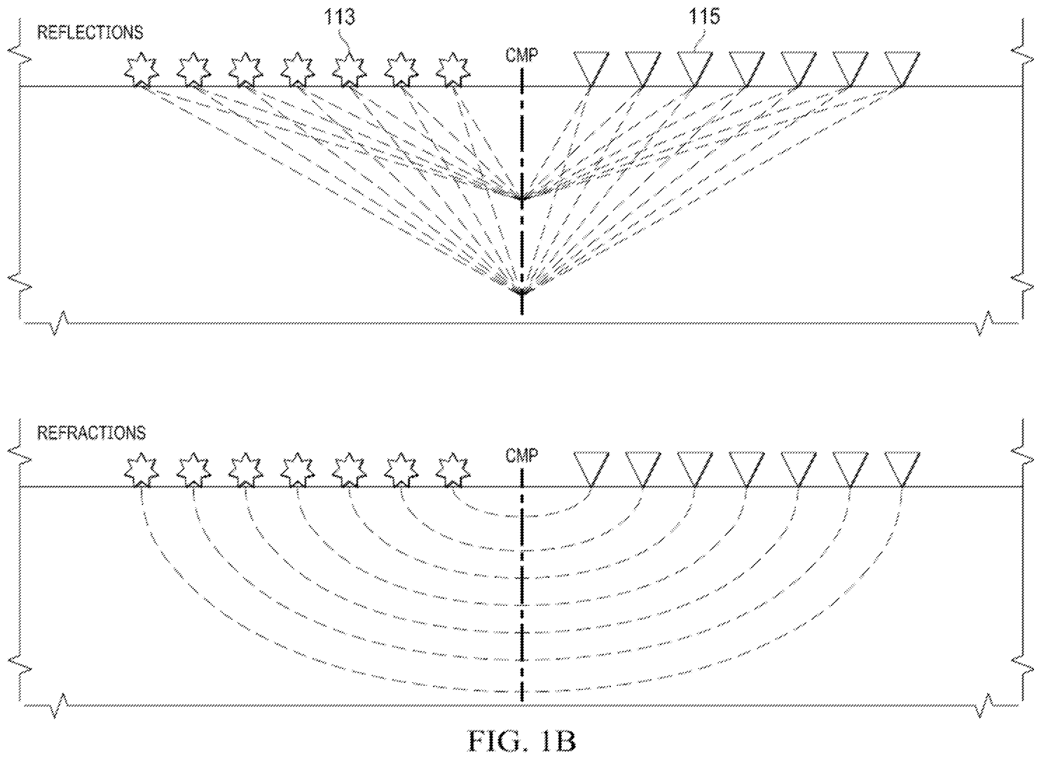

FIG. 1A is a schematic view of a seismic survey being performed to map subterranean features such as facies and faults in a subterranean formation 100. The subterranean formation 100 includes a layer of impermeable cap rock 102 at the surface. Facies underlying the impermeable cap rock 102 include a sandstone layer 104, a limestone layer 106, and a sand layer 108. A fault line 110 extends across the sandstone layer 104 and the limestone layer 106.

Oil and gas from source rocks rich in organic material tend to rise through permeable reservoir rock until further upward migration is blocked, for example, by the layer of impermeable cap rock 102. Seismic surveys attempt to identify locations where interaction between layers of the subterranean formation 100 are likely to trap oil and gas by limiting this upward migration. For example, FIG. 1A shows an anticline trap 107, where the layer of impermeable cap rock 102 has an upward convex configuration, and a fault trap 109, where the fault line 110 might allow oil and gas to flow in with clay material between the walls traps the petroleum. Other traps include salt domes and stratigraphic traps.

A seismic source 112 (for example, a seismic vibrator or an explosion) generates seismic waves that propagate in the earth. Although illustrated as a single component in FIG. 1A, the source or sources 112 are typically a line or an array of sources 112. The generated seismic waves include seismic body waves 114 that travel into the ground and seismic surface waves travel along the ground surface and diminish as they get further from the surface.

The velocity of these seismic waves depends on properties, for example, density, porosity, and fluid content of the medium through which the seismic waves are traveling. Different geologic bodies or layers in the earth are distinguishable because the layers have different properties and, thus, different characteristic seismic velocities. For example, in the subterranean formation 100, the velocity of seismic waves traveling through the subterranean formation 100 will be different in the sandstone layer 104, the limestone layer 106, and the sand layer 108. As the seismic body waves 114 contact interfaces between geologic bodies or layers that have different velocities and densities, each interface reflects some of the energy of the seismic wave and refracts some of the energy of the seismic wave. Such interfaces are sometimes referred to as horizons.

The seismic body waves 114 are received by a sensor or sensors 116. Although illustrated as a single component in FIG. 1A, the sensor or sensors 116 are typically a line or an array of sensors 116 that generate an output signal in response to received seismic waves including waves reflected by the horizons in the subterranean formation 100. The sensors 116 can be geophone-receivers that produce electrical output signals transmitted as input data, for example, to a computer 118 on a seismic control truck 120. Based on the input data, the computer 118 may generate a seismic data output, for example, a seismic two-way response time plot.

The seismic surface waves 115 travel more slowly than seismic body waves 114. Analysis of the time it takes seismic surface waves 115 to travel from source 112 to sensor can provide information about near surface features.

A control center 122 can be operatively coupled to the seismic control truck 120 and other data acquisition and wellsite systems. The control center 122 may have computer facilities for receiving, storing, processing, and analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subterranean formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subterranean formation or performing simulation, planning, and optimization of production operations of the wellsite systems.

In some embodiments, results generated by the computer systems 124 may be displayed for user viewing using local or remote monitors or other display units. One approach to analyzing seismic data is to associate the data with portions of a seismic cube representing the subterranean formation 100. The seismic cube can also display results of the analysis of the seismic data associated with the seismic survey.

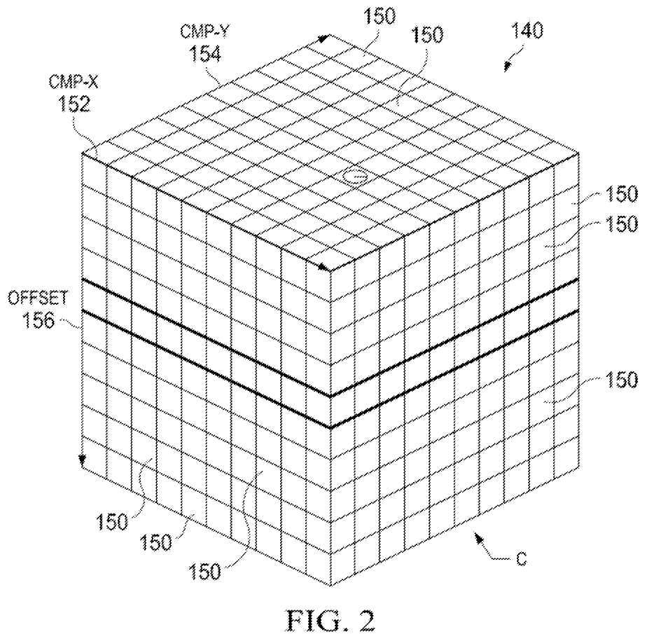

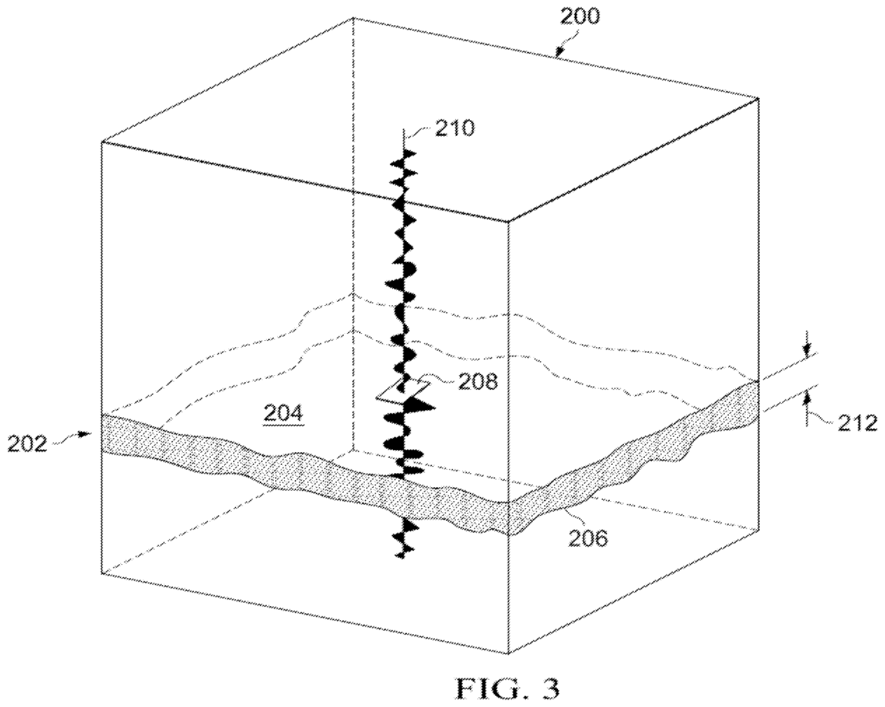

FIG. 1B illustrates incident and reflected rays at a common midpoint (CMP) position compared to refracted ray paths. In the idealized, one-dimensional (1D) model depicted in FIG. 1B (velocity increasing with depth), the offset (O) between a shot source (for example, source 113) and a receiver (for example, receiver 115) relates to the depth of penetration of the refracted waves. For refracted waves, an effective and concise representation of the subsurface structure is obtained by sorting or binning traces in a CMP-offset domain (referred to as XYO binning). After binning the received seismic traces (or the first break picks), statistics are calculated for each bin (for example, mean, median, mode, standard deviation, and cross-correlation). Multidimensional binning is applied to a 3D dataset of seismic traces as shown in FIGS. 2-3.

FIG. 2 illustrates seismic trace sorting into CMP-offset bins 150. The multi-dimensional attribute cubes or bins are used for quality control since these cubes or bins 150 enable a visualization of the spatial trends of the travel time (mean values) and the noisy areas (standard deviation). When performing the 3D CMP-offset binning (that is, XYO binning in the directions of CMP-X 152, CMP-Y 154, and offset 156), the bin sizes in the CMP-X 152 and CMP-Y 154 directions can be kept greater, such that a sufficient number of CMPs are placed in a bin 150 to provide functionally applicable statistics. The XYO binning illustrated in FIG. 2 is different from sorting in a common offset domain as the latter collects data sharing a common offset but pertaining to different CMPs. The existing CMP sorting (time-offset) that is applied for reflected waves is less useful for refracted waves as it would display events with variable velocities over the offset axis. The XYO binning method is therefore an effective representation of both CMP and offset domains where common properties at a CMP position can be assessed.

In some implementations, as shown in FIG. 2, the XYO space 140 is divided into XYO cubes or bins 150 of a particular size. For example, each bin 150 can have a size of 100 meters (m) in the CMP-X direction, 100 m in the CMP-Y direction, and 50 m in the offset direction. For each trace (or first break pick), the offset (the distance between the source and the receiver) and the CMP (the middle point position between the source and the receiver) are determined, and the trace is sorted into a particular bin based on the offset and the CMP. Each XYO bin 150 includes a collection of traces sharing a common (or similar) midpoint position and a common (or similar) offset. The collection of traces in an XYO bin is sometimes referred to as an XYO gather.

FIG. 3 illustrates a seismic cube 200 representing a formation. The seismic cube has a stratum 202 based on a surface (for example, an amplitude surface 204) and a stratigraphic horizon 206. The amplitude surface 204 and the stratigraphic horizon 206 are grids that include many cells such as exemplary cell 208. Each cell is a sample of a seismic trace representing an acoustic wave. Each seismic trace has an x-coordinate and a y-coordinate, and each data point of the trace corresponds to a certain seismic travel time or depth (t or z). For the stratigraphic horizon 206, a time value is determined and then assigned to the cells from the stratum 202. For the amplitude surface 204, the amplitude value of the seismic trace at the time of the corresponding horizon is assigned to the cell. This assignment process is repeated for all of the cells on this horizon to generate the amplitude surface 204 for the stratum 202. In some instances, the amplitude values of the seismic trace 210 within window 212 by stratigraphic horizon 206 are combined to generate a compound amplitude value for stratum 202. In these instances, the compound amplitude value can be the arithmetic mean of the positive amplitudes within the duration of the window, multiplied by the number of seismic samples in the window.

### III. Systems and Methods for Integrating Upholes With Inversion-based Velocity Modeling

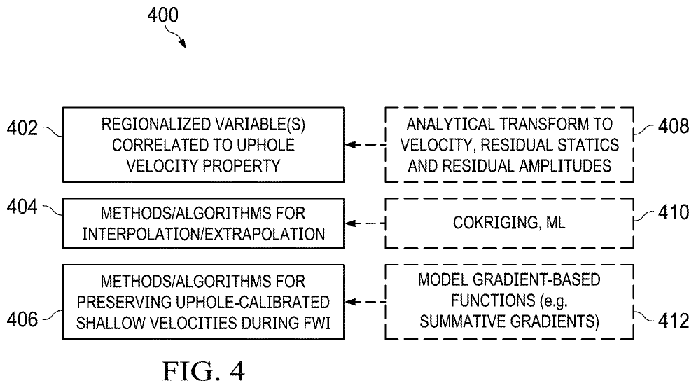

FIG. 4 illustrates a flowchart 400 that describes phases for generating uphole-calibrated near-surface velocities and preserving the uphole-calibrated near-surface velocities through an inversion-based velocity model building process, according to some implementations. In particular, as shown by blocks 402, 404, and 406, the operational challenges for integrating upholes with inversion-based methods include (1) defining one or more regionalized variables correlated to the uphole velocity property; (2) defining methods for the guided interpolation/extrapolation of the localized uphole velocity; and (3) defining methods for preserving uphole-calibrated shallow velocities in a large scale inversion.

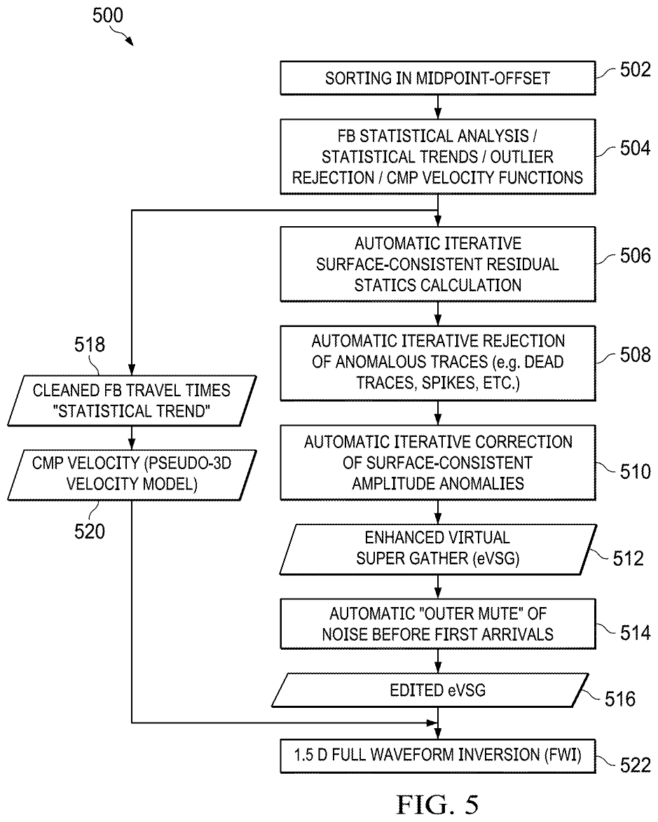

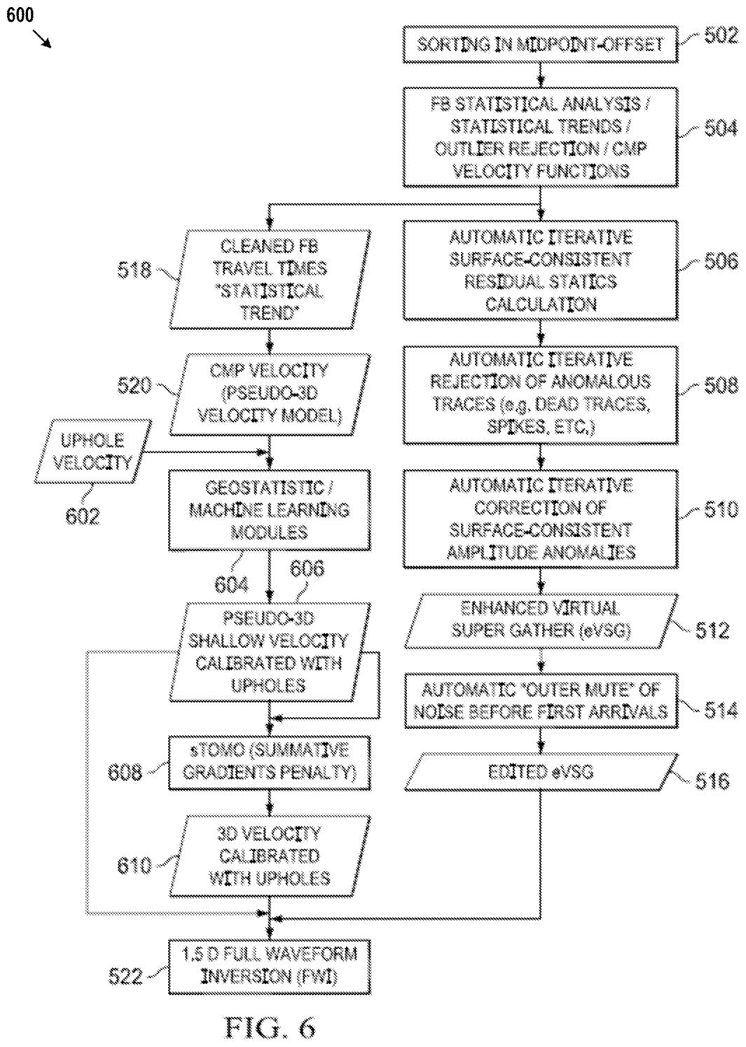

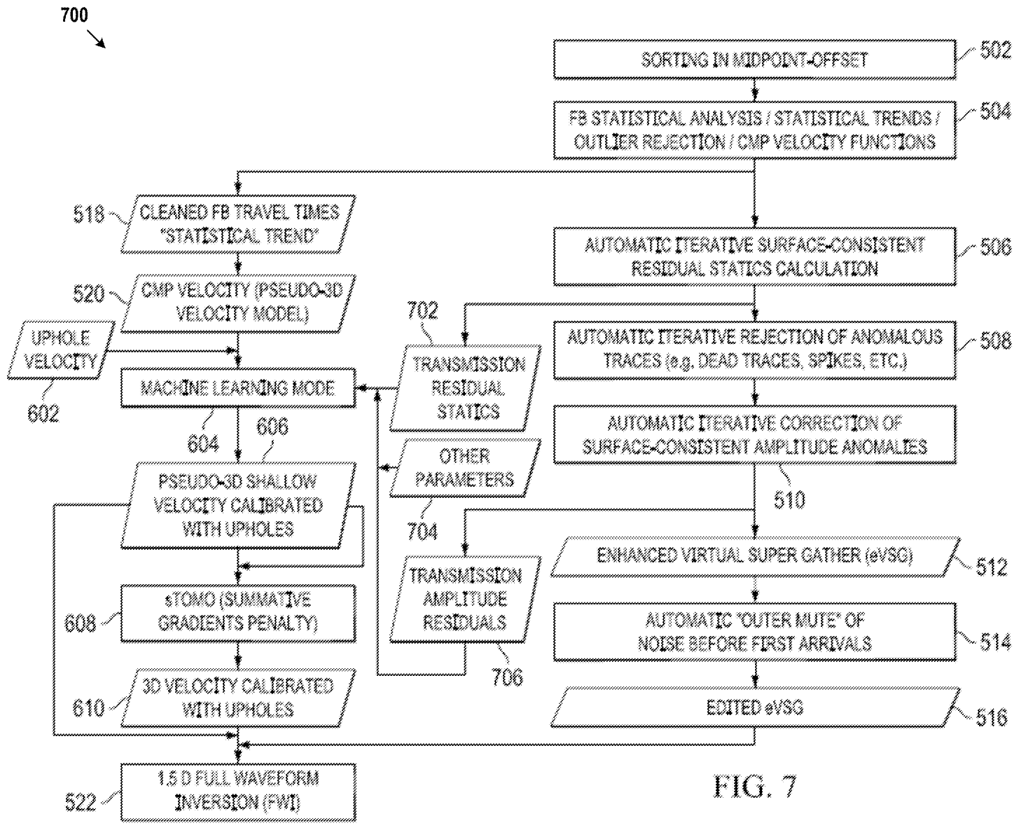

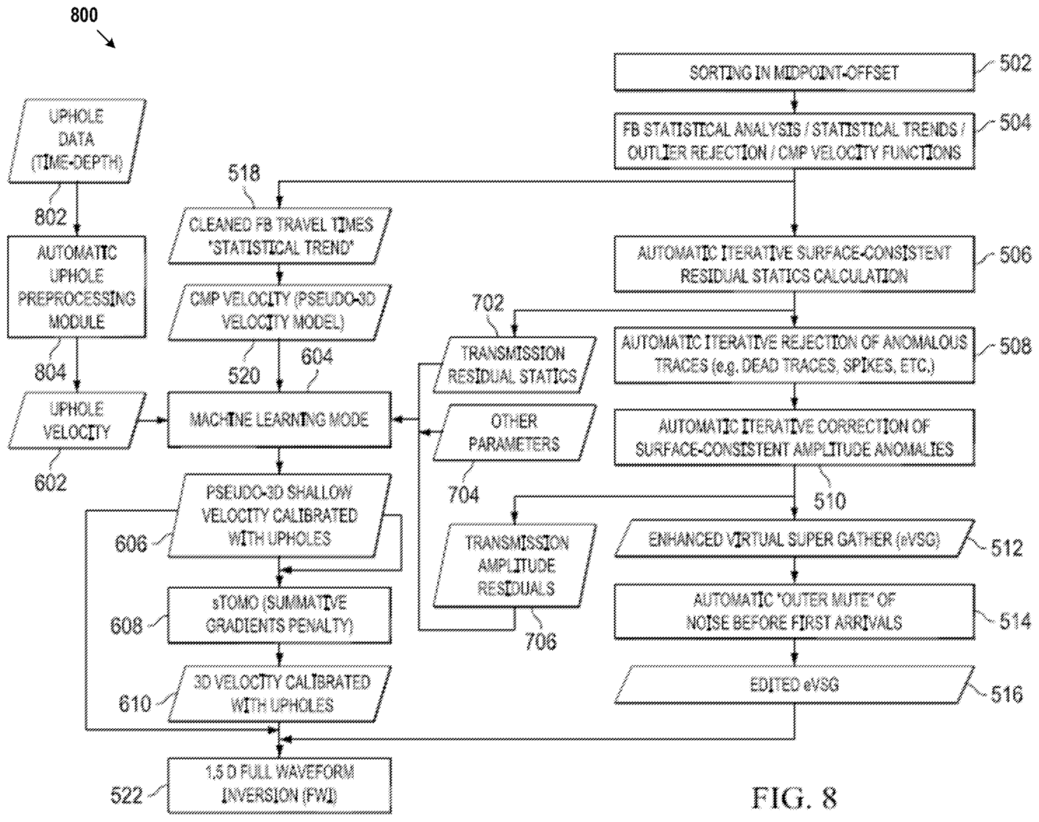

FIG. 4 also illustrates disclosed solutions to each of the operational challenges. Specifically, blocks 408, 410, and 412 include solutions to the operational challenges shown in blocks 402, 404, and 406, respectively. As described in more detail below, and as shown by blocks 402 and 408, the analytical transform to velocity, residual statics, and residual amplitudes are used to provide regionalized variables correlated to uphole velocity properties. As shown by blocks 404 and 410, co-kriging and machine learning are used to provide methods for interpolation/extrapolation. Further, as shown by blocks 406 and 412, model gradient-based functions, such as summative gradients, are used to provide methods for preserving uphole-calibrated shallow velocities during FWI. The methods associated with the solutions in blocks 408, 410, and 412 are shown in FIG. 5, FIG. 6, FIG. 7, and FIG. 8. The methods are briefly introduced before being described in more detail. Note that each of these methods can be performed by a computer system (described in more detail below).

FIG. 5 illustrates a workflow 500 for automatic data enhancement for Full Waveform Inversion (FWI) in the midpoint-offset domain, according to some implementations. The workflow 500 is described in more detail in U.S. patent application Ser. No. 17/237,746. In particular, the process involves a sorting domain described in U.S. Pat. No. 10,067,255, a surface-consistent analysis described in U.S. Pat. No. 10,386,519, surface-consistent corrections of amplitudes described in U.S. Pat. No. 10,852,450, and generation of virtual super shot gathers described in U.S. patent application Ser. No. 16/748,038. In particular, U.S. patent application Ser. No. 16/748,038 describes the process of generating virtual super gathers by stacking pilot traces in the midpoint-offset domain. The virtual super gathers are then used to demonstrate 1D Laplace-Fourier FWI using synthetic data.

FIG. 6 illustrates a workflow 600 that introduces a “geostatistics module” that integrates a shallow common midpoint (CMP) velocity model with uphole velocities, according to some implementations. In particular, the geostatistic module uses uphole velocities to calibrate the CMP velocity model. The geostatistic module generates a shallow velocity model that is calibrated with upholes. The geostatistic module can employ algorithms related to kriging, co-krigring, or machine-learning (ML).

FIG. 7 illustrates a workflow 700 that uses multiple near-surface related features to guide the uphole-calibrated near-surface velocity model, according to some implementations. FIG. 8 illustrates a workflow 800 that specifies a pre-processing module for uphole interpretation, according to some implementations. In this case, the workflow starts from the uphole raw data including travel time-depth pairs representing the measurements in the shallow borehole that need to be converted into velocity-depth functions.

Turning back to FIG. 5, the workflow 500 is used for automatic data enhancement for FWI in the midpoint-offset domain. Work on real seismic data, which is more affected by lower signal-to-noise (S/N) than simulated seismic data, has revealed that additional pre-processing work and corrections are needed for the virtual super gathers to be utilized for FWI. The mechanism of pre-processing the virtual super gathers to enhance S/N and prepare the data for the successive step of FWI is achieved by the workflow 500. In some examples, the steps of the workflow 500 are based on transmitted wavefields.

At step 502, the computer system sorts a plurality of seismic traces (included in the seismic data) into a plurality of common midpoint-offset bins (XYO bins). The seismic data is sorted in the midpoint-offset domain (XYO) where traces are grouped together to form a seismic gather. The seismic traces sorted into each XYO bin have the same X, Y, and offset (O) coordinates.

In some examples, for each XYO bin, the computer system applies a linear moveout (LMO) correction to a collection of seismic traces within the XYO bin. The collection of seismic traces is obtained from recorded seismic energy that travel from multiple seismic sources to multiple seismic receivers during a seismic survey. The dimensional offsets of the multiple seismic receivers can include a common midpoint X axis of the seismic survey, a common midpoint Y axis of the seismic survey, an offset axis, and an azimuth axis. A size of the LMO correction increases as a size of each common midpoint-offset bin increases. For example, the LMO correction is applied to the collection of seismic traces using an apparent velocity derived from a smooth spline fit evaluated at the central offset in the XYO bin. If the lateral velocity variations are small, the gather is generally flat near the first arrival. This property is exploited in order to recover residual statics.

The LMO correction is applied to enable the stacking of the transmitted (or refracted) waveforms. This correction is related to the size of the offset bin (XYO bin)—the greater the size of the offset bin, the greater the effect of the LMO correction. For the end-term case where a size of the offset bin is less enough to contain only one seismic trace, the LMO correction will be null. The LMO correction in the generation of the pilot trace emphasizes the contribution of the transmitted waveforms. For an offset bin having a greater size, the LMO correction will allow the transmitted energy to stack coherently while the reflected energy and the surface waves, that have a different moveout value, will be attenuated.

In some examples, the computer system stacks the collection of seismic traces within each XYO bin to form a pilot trace. The pilot seismic trace is generated from each XYO gather to calculate surface-consistent residual time shifts that are applied to sources and receivers. This step can be performed for each XYO bin.

At step 504, the computer system performs at least one of a first break (FB) statistical analysis, calculating statistical trends, performing rejection of outliers, or generating CMP velocity functions based on the seismic data in the XYO bins. Seismic data from seismic exploration surveys are mapped into a hypercube of bins or voxels in a four-dimensional space (X, Y, Offset, and Azimuth) according to Common Mid-Point (or CMP) between source and receivers. The mapped data from individual voxels or bins is then analyzed by multimodal statistics where outliers are rejected. Robust estimates of first break picks are obtained from the analysis. The robust first break picks in the CMP-offset (XYO) bin are used to evaluate mean travel times per XYO bin. The CMP-based travel time-offset functions are then converted to velocity-depth functions. The conversion to velocity-depth functions is described in the “Uphole pre-processing module” section below.

At step 506, the computer system performs automatic iterative surface-consistent residual statics calculation. In this step, the computer system determines a surface-consistent residual static correction for each seismic trace of the plurality of seismic traces within each XYO bin. This step is performed for each XYO bin and for each trace of the plurality of seismic traces within each XYO bin. To determine the surface-consistent residual static correction, the computer system determines a time shift based on cross-correlation of each seismic trace with the pilot trace of that XYO bin. The computer system provides the surface-consistent residual static correction based on inversion of the time shift for a seismic source position and a seismic receiver position. The time residual for each seismic trace is inverted for the source and receiver positions (that is, surface-consistent).

Then, the computer system determines whether the surface-consistent residual static correction for each seismic trace is less than a threshold. In some examples, the iterative procedure stops when there is no further correction estimated, such as when the further correction is less than or equal to the threshold (for example, a one-time sample). In other examples, the iterative procedure stops when successive iterations display an oscillatory character, for example, when the alignment or the traces worsen. The latter scenario can occur when noise is being inverted. In other examples, the threshold is selected by a user. This step is performed for each XYO bin and for each trace of the collection of seismic traces within each XYO bin. Responsive to determining that the surface-consistent residual static correction is greater than the threshold, the computer system applies the surface-consistent residual static correction to each seismic trace in an iterative manner. A new pilot trace is evaluated for each XYO bin (XYO gather) and the process is iterated until the inverted surface-consistent residual statics updates are zero or less than the pre-defined threshold.

For inverting for surface-consistency at each iteration, the time shift corrections for each seismic trace are regularized across the entire seismic survey to ensure robustness and redundancy. The iterations are performed to generate updated surface-consistent time shifts and updated pilot traces until the time correction is null or cannot further decrease, and the pilot trace provided represents all the other seismic traces in the XYO gather.

Furthermore, responsive to determining that the surface-consistent residual static correction is less than the threshold, the computer system stacks the collection of seismic traces within each XYO bin to provide the pilot trace for that XYO bin. This step is performed for each XYO bin and for each trace of the collection of seismic traces within each XYO bin. The repetition of the process for each XYO bin results in the generation of a virtual shot gather for the XY midpoint position. Since each seismic trace in the virtual shot gather is the result of a stacking process, the signal-to-noise (S/N) ratio is increased by making coherent signals stronger and uncorrelated signal (noise) weaker.

Additionally, the computer system groups the pilot traces for the multiple XYO bins into multiple virtual shot gathers. Each virtual shot gather includes a collection of pilot traces having the same X and Y coordinates and different O coordinates. Thus, the process is repeated for all the available offsets to reconstruct a full virtual shot gather including a combination of all the pilot traces. The full virtual shot gather is an expression of a virtual shot gather at a given XY midpoint position. The artificially reconstructed pre-stack gather resembles the seismic shot gather at a surface position, consistent with the XY midpoint position, with increased accuracy and a greater S/N ratio.

Stacking, as previously described, generally includes adding and averaging multiple traces together to improve the signal-to-noise ratio of the combined trace. The signal-to-noise ratio, or S/N, increases by the square root of the number of traces in the stack. The stacking process improves S/N when the noise is randomly distributed and superimposed to coherent signal. Weighted stacking is an additional approach to weight the contribution of each trace to the process, for example by their cross-correlation coefficient. Given that the stacking process is averaging, it is subject to the effect of outliers that influence the outcome of the operation. The data processing system is configured to evaluate individual anomalous amplitude traces for removal (elimination) before proceeding to the stacking process.

At step 508, the computer system automatically rejects anomalous traces (for example, dead traces and spikes). The computer system performs step 508 before the evaluation and correction of the surface-consistent amplitude anomalies performed in step 510. In particular, the computer system performs, at step 510, an iterative correction of surface-consistent amplitude anomalies the automatic correction of surface-consistent amplitude anomalies, perhaps by scalar or deconvolution approaches.

At step 512, the computer system generates an enhanced virtual super gather (eVSG). The computer system performs step 512 by stacking the traces contained in the XYO bin after these have been corrected by automatic iterative surface-consistent residual statics (at step 506), automatic iterative rejection of anomalous traces (at step 508), and automatic iterative correction of surface-consistent amplitude anomalies (at step 510), as previously described. The stacking process can include simple averaging (for each time sample the mean value of the amplitudes in the XYO gather), a weighted stack (each trace in the XYO is multiplied by a weight from the cross-correlation coefficient to the pilot trace and then the mean is calculated), a median stack (for each time sample the median amplitude is considered and selected), or one or more other similar processes. The eVSG is a VSG having S/N improvement obtained through surface-consistent approaches that preserve frequency content, provide balanced amplitudes and remove bad traces. The eVSG is also a virtual gather reconstructed at the CMP (the source-receiver midpoint position). As such, the computer system can use the eVSG for seismic data processing operations such as first break picking, velocity analysis (normal moveout—NMO velocity picking), CMP stacking, and time/depth imaging (migration).

At step 514, the computer system performs post-stack processing on the eVSG data to prepare the data for 1.5D FWI. These additional processes are typically performed by the computer system to prepare the generated eVSG for the 1.5D FWI. Depending on what type of FWI domain is used, different processing steps are performed. The VSG are volumetric averages and therefore describe an average 1D behavior. As such, the VSG are well described by 1.5D FWI, which is a 1D model, but is called 1.5D because an offset is included. Generally, the post-stack processing is performed not because of the way the VSG are generated but to remove signal that is not modeled by the forward modeling engine.

In one example, the computer system automatically “mutes” noise before first arrivals. In another example, acoustic forward modeling (P-waves) are used, and what is muted is related to surface waves. These are muted because they are not being modeled by the acoustic forward modeling engine. The computer system performs the mute. A digital removal of arrivals before the first breaks (a sharp division in offset-time space between elements that are retained unchanged in magnitude and those deleted entirely) generally may not be necessary for FWI processes working in the time domain. When using FWI in the Fourier (that is, frequency) and in the Laplace-Fourier domains, the computer system removes noise and unwanted signals before the onset of the seismic waves. The computer system thus mutes all the signals before the first arrivals (first break travel times). This operation can be performed automatically in different ways. The output of this operation is an edited eVSG, as shown by step 516. Note that in some examples step 514 is not necessary, and therefore, is not performed by the computer system.

At step 518, the computer system generates cleaned first break travel times statistical trend data. The data processing system can use this statistical trend data to generate a robust estimate of the seismic wave onset time to be used for muting purposes. In an example, the computer system uses a supervised machine learning approach, in which an automated supervised learning the first break travel time statistical trends are used to provide training of a convolutional neural network (CNN). In this example, the CNN predicts (and possibly refines) the first break travel time prediction.

At step 520, the computer system generates a CMP velocity model based on the cleaned first break travel times statistical trend data. In particular, the robust first break picks in the CMP-offset (XYO) bin are used to evaluate mean travel times per XYO bin. The CMP-based travel time-offset functions are then converted to velocity-depth functions using analytical time-depth transforms or via 1D inversion. At step 522, the computer system can use the CMP velocity model (pseudo-3D velocity model) and the edited eVSG to perform 1.5D FWI. Here, the FWI deterministic inversion uses the CMP velocity model as starting velocity model for the inversion process. The eVSG gathers are the input seismic data for the 1.5D FWI process. The result enables accurate corrections for the near surface can occur because high-resolution velocity models are represented for land seismic data. The process performed by the computer system provides a unique approach for enhancing the SN content of the data by a series of surface-consistent steps. The described method is applicable in the time domain, frequency-domain, and Laplace-Fourier FWI domain. The workflow 500 is described in more detail in U.S. patent application Ser. No. 17/237,746.

FIG. 6 illustrates the workflow 600 for integrating uphole velocities into the FWI velocity model building workflow. As shown in FIG. 6, the workflow 600 builds on the workflow 500 by adding steps 602-610.

At step 602, the computer system receives uphole vertical velocity data. At step 604, the computer system provides the uphole vertical velocity and the CMP-based velocity as input to a geostatistic module. The geostatistic module performs the interpolation of uphole velocities using a regionalized parameter distribution as a guide. The CMP-velocity model provides the regionalized parameter distribution that is used for the uphole interpolation. In some examples, the geostatistic module performs this operation using geostatistic techniques such as kriging/co-kriging. In other examples, the geostatistic module performs this operation using ML/DL techniques (described in more detail below). The outcome of this step is a pseudo-3D velocity model calibrated by uphole velocities.

At step 606, the computer system uses the pseudo-3D shallow velocity calibrated with upholes as a starting velocity model. The computer system also uses the pseudo-3D shallow velocity calibrated with upholes as a penalty function with gradient-based penalty functions such as “summative gradients” (described in more detail below). In step 608, the computer system applies the penalty function to constrain 3D tomography (for example, structure tomography [sTOMO]) to generate a 3D velocity model calibrated with upholes. Gradient-based coupling operators, such as “summative gradients,” preserve the derived calibrated shallow velocity model during tomographic and FWI processes. The computer system then uses the 3D velocity model calibrated with upholes as input to 1.5D FWI. Steps 606 and 608 are explained in more detail in the “Structure Algorithms Module” below.

FIG. 7 illustrates the workflow 700 for integrating uphole velocities into the workflow of FWI velocity model building. As shown in FIG. 7, in addition to the steps of the workflow 600 of FIG. 6, the workflow 700 includes steps 702-706. In particular, to achieve the workflow 700, the workflow 600 is modified to account for a plurality of parameters that can be used as regionalized variable distributions. The plurality of regionalized variables are correlated to shallow velocities and, as such, one or more of them can be used for constraining the uphole spatial interpolation/extrapolation. In particular, the output of the automated pre-processing/pre-conditioning sequence can use transmission residual statics and transmission amplitude residuals as regionalized variables correlated to the near surface velocity parameter distributions. As such, as shown by steps 702 and 704, the computer system can use the output of steps 506 and 510, respectively, to calculate the transmission residual statics 702 and transmission amplitude residuals 706.

In some examples, additional parameter distributions can be utilized for this purpose including a topographic surface, satellite images such as hyperspectral/multispectral remote sensing, space-based radar, vibrator plate attributes, surface wave velocity, among other examples. As such, as shown by step 704, the computer system can calculate additional parameter distributions. The integration (that is, interpolation/extrapolation) module becomes a ML/DL module that builds multi-dimensional regression functions between the seeded uphole velocity parameter and the rest of the regionalized parameters expressing functions of the near surface parameter distributions. This operation can be performed using supervised, unsupervised ML methods, or a combination of both.

FIG. 8 illustrates the workflow 800 that further specifies a pre-processing module for uphole interpretation. Here, uphole velocities are added to the workflow and integrated in the derivation of calibrated FWI velocities. As such, the computer system starts the workflow 800 at step 802 by receiving uphole raw data. The uphole raw data includes travel time-depth pairs that represent measurements in the shallow borehole that are to be converted into velocity-depth functions. The operation is complicated by the presence of noise in the travel time measurements requiring specific strategies for avoiding false and misleading velocity estimations. As such, the workflow 800 includes additional regionalized variables and includes an automatic module is specified for pre-processing of the noisy uphole data. The uphole pre-processing module of step 804 is described in more detail below.

### ML Module

Traditional geostatistical techniques have been applied in practice to predict property values at unobserved areas from measured locations, often with limited point supports. In the case of velocity model estimation, due to the near surface heterogeneity, the underlying velocity distribution can be too complex to be approximated by classical statistical models, especially for those only based on second order moments such as kriging and its variants.

Machine learning in both classical forms and more recent deep learning techniques are promising alternatives to geostatistical techniques for spatial interpolation/extrapolation. This is especially the case for applications with high dimensional, complex, and heterogeneous distributions with nonlinear functional relationships, such velocity modeling. Classical machine learning methods such as Nearest-Neighbor (NN) interpolation, k-nearest-neighbors (kNN), Random forests (RF) with inverse distance squared (IDS), and multi-layer perceptron (MLP) have been applied for spatial interpolation and extrapolation. Deep learning approaches have increasingly been used to understand spatial property distributions and geophysical processes from a data-driven perspective. Models, such as convolutional neural networks (CNNs), have proven to be capable of high-dimensional data representation and function approximation, and as effective building blocks for various deep learning networks for geophysics inversion. The optimization process back-propagates gradients of the loss function objective through the linear transform layers combined with non-linear activations. The trained networks learn a representation that maps the input into an ideal output representation by capturing the deep features. The local kernel characteristics of the CNN's architecture with shared weights is consistent with the spatial approximation objective.

In some embodiments, the disclosed workflows (for example, in machine learning module 602) use conditional deep learning frameworks for spatial interpolation and extrapolation that enable uphole velocity calibration of a FWI velocity model. In particular, the frameworks integrate the distribution of a number of different properties or attributes, such as the CMP velocity, the residual statics, and the amplitude residuals. These frameworks can be added into a FWI velocity modeling process as a subsequent calibration procedure, or can be integrated into a machine learning based FWI inversion process by reusing some of the deep learning modules both as part of inversion and as part of the calibration process.

### Conditional Variational Auto-Encoder or a Conditional U-Net

In an embodiment, a first framework is a conditional image-to-image mapping network. In this embodiment, a FWI velocity serves as an input image (2D or 3D), the uphole velocity and the distribution of CMP velocity/residual/statics are treated as the conditional inputs, and the output image is the calibrated FWI velocity. This embodiment can be used in scenarios with abundant training data, including uphole velocity, additional properties such as CMP velocity, statics and residuals, as well as FWI velocity. The image-to-image mapping network is established via a variational auto-encoder with conditional constraints and a conditional U-net structure.

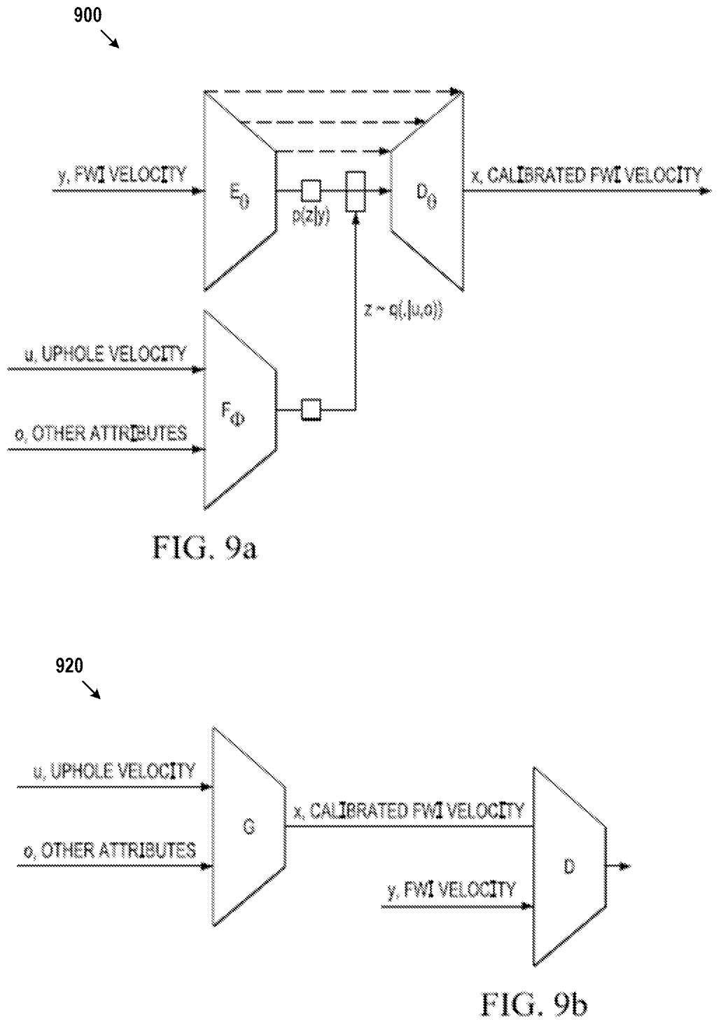

FIG. 9A illustrates conditional image-to-image mapping network 900. In FIG. 9A, x is a calibrated FWI velocity, y is an input FWI velocity, z is a latent velocity model, u is an uphole velocity, and o represents other attributes. The network 900 can be a variational auto-encoder or conditional U-net, depending on whether or not skip connections are used. In both cases, the initial FWI velocity is provided as input to the encoder EΘ and is mapped into a calibrated FWI velocity through the auto-encoder/U-net network, with its conditional distribution controlled by the uphole velocity as well as the other attributes, through variational constraints. Thus, E is the encoder function parameterized by “theta” (weights and biases), and D is the decoder function also parameterized by “theta.”

Conditional Generative Adversarial Network (cGAN)

In an embodiment, a second framework is a semi-supervised Generative adversarial networks (GAN) structure. This embodiment can be used in scenarios where training data is not necessarily sufficient. More specifically, the GAN structure includes generating calibrated velocity model conditioned on the uphole velocity and other attributes.

The GAN framework includes a generator, G, which attempts to capture the data distribution, and a discriminator, D, which estimates the probability that a sample comes from the real dataset rather than G. G typically maps a noise vector, z, from the prior distribution to the data space. The discriminator, D, outputs a single scalar representing the probability that the input data come from the training set rather than the generated samples of G. G and D are trained following a two-player minimax optimization. So, G is trained to maximally confuse the discriminator and D is adjusted to make the best judgement. Accordingly, the objective function is represented by Equation [1]:

$${min}_{θ g} {max}_{θ d} {E}_{x} [ log D ( x ) ] + {E}_{z} [ log ( 1 - D ( G ( z ) ) ) ] . \qquad [ 1 ]$$

The training of the adversarial network can be conducted by simultaneously updating θ_{d} and θg, which can be achieved by descending the stochastic gradient of logistic loss functions.

The GAN can be extended to a conditional version, named cGAN, by conditioning both G and D on the same auxiliary information. In previous works, the prior input noise vector z and the condition y were combined jointly as low-dimensional inputs for G to generate different random artificial data under the same condition, while the discriminator receives x and y as inputs to make a determination based on y without considering z. The objective function of a CGAN is formalized as shown by Equation [2]:

$${min}_{θ g} {max}_{θ d} {E}_{x} [ log D ( x , y ) ] + {E}_{z} [ log ( 1 - D ( G ( z , y ) , y ) ) ] . \qquad [ 2 ]$$

In this disclosure, for the purposes of spatial interpolation/extrapolation of uphole data, the random noise vector z in the generator is replaced by the input FWI velocity model. The uphole velocity is taken as the conditioning input as shown by Equation [8]:

$${min}_{θ g} {max}_{θ d} {E}_{x \vert u , o} [ log D [ x \vert u , o \text{)]} + {E}_{x \vert u , o} [ log ( 1 - D ( G ( u , o ) , x ) \vert u , o ) \text{)]} . \qquad [ 3 ]$$

FIG. 9B illustrates a GAN framework 920, according to some implementations. In FIG. 9B, x is a calibrated FWI velocity, y is an input FWI velocity, u is an uphole velocity and o represents other attributes. As shown in FIG. 9B, the calibrated FWI velocity is produced from the generator based on the uphole velocity and other attributes, through an optimized generator G that aims to make it as close to the initial FWI inverted velocity as possible. The optimized discriminator D distinguishes between the predicted calibration and the initial FWI velocity.

### Structure Algorithms Module

As described above, the disclosed workflows can involve applying a penalty function to 3D tomography, to 1.5D FWI, or generally, to any 3D FWI process. This disclosure focuses on a specific structure penalty function called “summative gradients,” however, other penalty functions are possible and contemplated herein.

Any of the previously mentioned inversion processes can be formulated as a constrained least squares problem solved by minimizing a composite objective function consisting of a data misfit, intra-domain operators, and other inter-domain operators. In this disclosure, only the subset of inter-domain operators that are constraining the shape of the parameter distributions, also called structure operators, are considered. It is contemplated that other penalty functions can also be used such as “compositional” or rock-physics. The composite objective function takes the form shown by Equation [4]:

ϕₜ(m)=ϕ_{d}(m)μ₁ϕₘ(m)+μ₂ϕₓ(m) [4]

In Equation [4], m is the unknown velocity model, and μ₁ and μ₂ are misfit weights. The data misfit, ϕ_{d} (m), is defined in Equation [5] as:

ϕ_{d}(m)=(Jm−d_{obs})^{T}W_{d}^{T}W_{d}(Jm−d_{obs})=∥W_{d}(Jm−d_{obs})∥_{L}_{₂}². [5]

In Equation [5], d_{obs} is the vector of the observed data, J is the Jacobian or the sensitivity matrix, and W_{d} is a data weighting (or covariance) matrix that accounts for the relative importance of the observations and the effect of the noise in the data. The model regularization function ϕₘ(m) is defined in Equation [6] as:

ϕₘ(m)=(m−m₀)^{T}Wₘ^{T}Wₘ(m−m₀)=∥Wₘ(m−m₀)∥_{L}_{₂}². [6]

In Equation [6], m₀ is the prior model and Wₘ is a model weighting (or covariance) matrix that includes spatially dependent weighting functions, a model smoothing operator, and prior information related to the model. The smoothing operator is implemented through a Laplacian operator (L). The remaining misfit term ϕₓ (m) is a structure operator defined in Equation [7]:

ϕₓ(m)=Σ_{q=1}^{Q}w_{q}|sc_{q}(m,m_{ref})|²=Σ_{q=1}^{Q}w_{q}x_{q}²=x^{T}Wₓ^{T}Wₓx=∥Wₓx∥_{L}_{₂}². [7]

In Equation [7], m_{ref} is a reference velocity model built from the uphole information, sc_{q}(m, m_{ref}) is a structural constraint vector at the grid cell q, Q is a total number of the grid cells, x_{q}=|sc_{q} (m, m_{ref})|; w_{q} is a weight given to x_{q}. Further, x and Wₓ are, respectively, a structural operator vector and a covariance matrix between the unknown models m and the reference model m_{ref}.

The summative gradient structure operator is evaluated as the sum (or the difference) of the normalized spatial gradients of two models m and m_{ref} for each of their cell q, as shown by Equation [8]:

$$s {c}_{q} ( m , {m}_{ref} ) = \frac{∇ m}{\sqrt{{\vert ∇ m \vert}^{2} + {ε}^{2}}} + h \frac{∇ {m}_{ref}}{\sqrt{{\vert ∇ {m}_{ref} \vert}^{2} + {ε}^{2}}} . \qquad [ 8 ]$$

In Equation [8], his a correlation sign equal to ±1. When h=−1, it assumed that m and m_{ref} are positively correlated. Conversely, it is assumed that m and m_{ref} are negatively correlated when h=1. The denominators in Equation [8] are introduced to normalize the different values of the two gradients, and ε is a small constant to avoid zeros (damping). The module of the structure constrain vector is zero when the two normalized gradients have the same values (for positive correlation) or opposite values (for negative correlation). Notably, when one of the two models is constant, the corresponding term in Equation [8] is zero, but the structure operator will not be zero. In this case, the minimization of the structure objective function will tend to reduce the module of the surviving gradient term to constrain the model to assume constant parameter distributions. The structure term shown in Equation [8] is zero if both the models are constant. The behavior of this operator is stable, but makes the assumption that the sign of the correlation is known everywhere in the models.

### Uphole Pre-Processing Module

In some embodiments, uphole pre-processing module can be conceptually divided into three steps: (i) spline fitting, (ii) spline simplification/traveltime-to-velocity conversion, and (iii) interval velocity interpolation. These steps are described in more detail below.

### Step 1: Cubic Hermite Spline Fitting

The input for this process is a set of travel-times versus depth measurements, tᵢ(xᵢ), i=1, 2, . . . , N, where xᵢ is the depth at which the i-th sample was collected. The samples are assumed to be sorted with the depth monotonically increasing. Additionally, a set of monotonically increasing knot locations xⱼ^{knot}, j=1, 2, . . . , M should either be provided by the user, or computed automatically, for example, by dividing the depth range

$$[ {min}_{i} \{ {x}_{i} \} , {max}_{i} \{ {x}_{i} \} ]$$

in M−1 equispaced intervals. In any case, the knot locations should be chosen such that

$$[ {min}_{i} \{ {x}_{i} \} , {max}_{i} \{ {x}_{i} \} ] {x}_{1}^{k n o t} \leq {min}_{i} \{ {x}_{i} \} and {x}_{M}^{k n o t} \leq {max}_{i} \{ {x}_{i} \} .$$

That is, all input samples should fall within some knot interval [xⱼ^{knot}, xⱼ₊₁^{knot}].

In some embodiments, a function s(i) maps the i-th sample to the knot interval index j, such that xᵢ∈[xⱼ^{knot}, xⱼ₊₁^{knot}]. xᵢ is defined in Equation [9] as:

$${\hat{x}}_{i} = \frac{{x}_{i} - {x}_{s ( i )}}{{x}_{s ( i ) + 1} - {x}_{s ( i )}} ∈ [ 0 , 1 ] . \qquad [ 9 ]$$

Equation [9] is a normalized version of the depth within the knot interval. Fitting a cubic Hermite spline then becomes a problem of choosing parameters pⱼ, mⱼ, j=1, 2, . . . , M, such that:

tᵢ(xᵢ)=(2\hat{x}ᵢ³−3\hat{x}ᵢ²+1)pₛ₍ᵢ₎+(−2\hat{x}ᵢ³+3\hat{x}ᵢ²)pₛ₍ᵢ₎₊₁(\hat{x}ᵢ³−2\hat{x}ᵢ²+\hat{x}ᵢ)mₛ₍ᵢ₎+(\hat{x}ᵢ³−\hat{x}ᵢ²)mₛ₍ᵢ₎₊₁. [10]

The parameters represent the value of the spline and its first derivative at xⱼ^{knot} respectively. One such equation can be written for each of the samples, leading to a linear system of N equations and 2M unknowns as shown in Equations [11]-[16]:

t=Ap, where: [11]

t=[t₁(x₁),t₂(x₂), . . . ,t_{N}(x_{N})]^{T} [12]

p=[p₁,p₂, . . . p_{M},m₁,m₂, . . . m_{M}]^{T}, [13]

and

A_{i,s(i)}=2\hat{x}ᵢ³−3\hat{x}ᵢ²+1, [14]

A_{i,s(i)+1}=−2\hat{x}ᵢ³+3\hat{x}ᵢ², [15]

A_{i,M+s(i)}=\hat{x}ᵢ³−2\hat{x}ᵢ²+\hat{x}ᵢ, [16]

A_{i,M+s(i)+1}=\hat{x}ᵢ³−\hat{x}ᵢ², [17]

In these Equations, A_{i,j} is the (i, j)-th element of A. In the absence of any additional constraints, A is in the general case sparse, having 4 nonzero elements per row. Owing to the presence of noise and outliers in the traveltime data, [11] will not be exactly satisfied. To address this issue, p is fit by solving the optimization problem:

$${p}_{opt} = {arg min}_{p} \{ d ( t - A p ) \} . \qquad [ 17 ]$$

In Equation [17], d(⋅) is a chosen functional. This takes the form of an l₂-norm, but another functional can be also used, such as an lₚ-norm, 0<p<2, or the Huber cost function, which are more robust against outliers.

### Step 2: Spline Simplification and Traveltime-to-Velocity Conversion

In the second step, the spline is evaluated at the same depth locations as the input points, by calculating the spline as shown in Equation [18]:

t^{spline}=Apₒₚₜ. [18]

The spline is then iteratively simplified using the Douglas-Peucker method, which iteratively removes elements from t^{spline} such that the resulting piecewise linear function is a good approximation of the original spline. The simplification process yields a new N^{smp}×1 vector, t^{smp}. Interval velocities can be extracted from the piecewise linear function defined by t^{smp}:

$${v}_{k} = \frac{{x}_{k + 1}^{s m p} - {x}_{k}^{s m p}}{t ( {x}_{k + 1}^{s m p} ) - t ( {x}_{k}^{s m p} )} , \qquad [ 19 ]$$

In Equation [19], vₖ is the interval velocity of the layer [xₖ^{smp}, Xₖ₊₁^{smp}], k=1, 2, . . . , N^{smp}.

### Step 3: Interpolation of the Interval Velocities

In some embodiments, if it is desired to evaluate the interval velocity model at particular depths, this can be done by interpolation. The velocities v₁, v₂, . . . , V_{N}_{^{smp}} define a piecewise constant function that can be interpolated trivially. Let x_{q} be a depth location at which the interval velocity is to be recovered. The corresponding velocity V_{q} is given by:

v_{q}=vₖ, [20]

with k such that:

xₖ^{smp}≤X_{q}≤Xₖ₊₁^{smp}. [21]

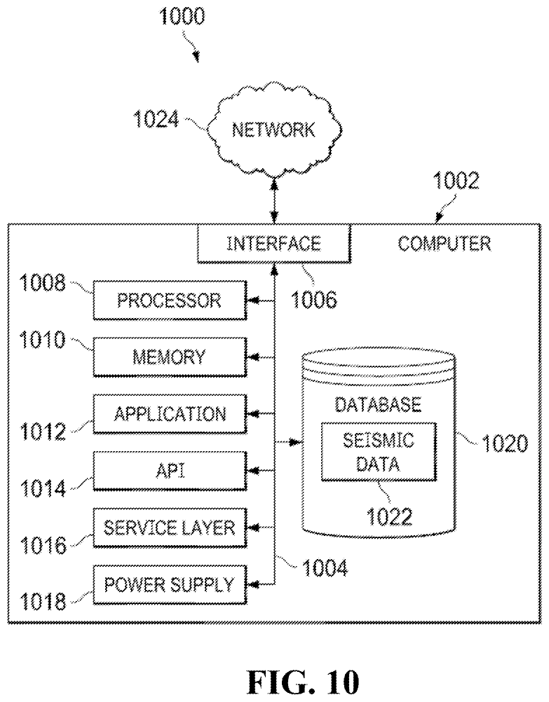

FIG. 10 is a block diagram of an example computing system 1000 used to provide computational functionalities associated with described algorithms, methods, functions, processes, flows, and procedures described in the present disclosure, according to some implementations of the present disclosure. The illustrated computer 1002 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1002 can include input devices such as keypads, keyboards, and touch screens that can accept user information. Also, the computer 1002 can include output devices that can convey information associated with the operation of the computer 1002. The information can include digital data, visual data, audio information, or a combination of information. The information can be presented in a graphical user interface (UI) (or GUI).

The computer 1002 can serve in a role as a client, a network component, a server, a database, a persistency, or components of a computer system for performing the subject matter described in the present disclosure. The illustrated computer 1002 is communicably coupled with a network 1024. In some implementations, one or more components of the computer 1002 can be configured to operate within different environments, including cloud-computing-based environments, local environments, global environments, and combinations of environments.

At a high level, the computer 1002 is an electronic computing device operable to receive, transmit, process, store, and manage data and information associated with the described subject matter. According to some implementations, the computer 1002 can also include, or be communicably coupled with, an application server, an email server, a web server, a caching server, a streaming data server, or a combination of servers.

The computer 1002 can receive requests over network 1024 from a client application (for example, executing on another computer 1002). The computer 1002 can respond to the received requests by processing the received requests using software applications. Requests can also be sent to the computer 1002 from internal users (for example, from a command console), external (or third) parties, automated applications, entities, individuals, systems, and computers.

Each of the components of the computer 1002 can communicate using a system bus 1004. In some implementations, any or all of the components of the computer 1002, including hardware or software components, can interface with each other or the interface 1006 (or a combination of both), over the system bus 1004. Interfaces can use an application programming interface (API) 1014, a service layer 1016, or a combination of the API 1014 and service layer 1016. The API 1014 can include specifications for routines, data structures, and object classes. The API 1014 can be either computer-language independent or dependent. The API 1014 can refer to a complete interface, a single function, or a set of APIs.

The service layer 1016 can provide software services to the computer 1002 and other components (whether illustrated or not) that are communicably coupled to the computer 1002. The functionality of the computer 1002 can be accessible for all service consumers using this service layer. Software services, such as those provided by the service layer 1016, can provide reusable, defined functionalities through a defined interface. For example, the interface can be software written in JAVA, C++, or a language providing data in extensible markup language (XML) format. While illustrated as an integrated component of the computer 1002, in alternative implementations, the API 1014 or the service layer 1016 can be stand-alone components in relation to other components of the computer 1002 and other components communicably coupled to the computer 1002. Moreover, any or all parts of the API 1014 or the service layer 1016 can be implemented as child or sub-modules of another software module, enterprise application, or hardware module without departing from the scope of the present disclosure.

The computer 1002 includes an interface 1006. Although illustrated as a single interface 1006 in FIG. 10, two or more interfaces 1006 can be used according to particular needs, desires, or particular implementations of the computer 1002 and the described functionality. The interface 1006 can be used by the computer 1002 for communicating with other systems that are connected to the network 1024 (whether illustrated or not) in a distributed environment. Generally, the interface 1006 can include, or be implemented using, logic encoded in software or hardware (or a combination of software and hardware) operable to communicate with the network 1024. More specifically, the interface 1006 can include software supporting one or more communication protocols associated with communications. As such, the network 1024 or the hardware of the interface can be operable to communicate physical signals within and outside of the illustrated computer 1002.

The computer 1002 includes a processor 1008. Although illustrated as a single processor 1008 in FIG. 10, two or more processors 1008 can be used according to particular needs, desires, or particular implementations of the computer 1002 and the described functionality. Generally, the processor 1008 can execute instructions and can manipulate data to perform the operations of the computer 1002, including operations using algorithms, methods, functions, processes, flows, and procedures as described in the present disclosure.

The computer 1002 also includes a database 1020 that can hold data (for example, seismic data 1022) for the computer 1002 and other components connected to the network 1024 (whether illustrated or not). For example, database 1020 can be an in-memory, conventional, or a database storing data consistent with the present disclosure. In some implementations, database 1020 can be a combination of two or more different database types (for example, hybrid in-memory and conventional databases) according to particular needs, desires, or particular implementations of the computer 1002 and the described functionality. Although illustrated as a single database 1020 in FIG. 10, two or more databases (of the same, different, or combination of types) can be used according to particular needs, desires, or particular implementations of the computer 1002 and the described functionality. While database 1020 is illustrated as an internal component of the computer 1002, in alternative implementations, database 1020 can be external to the computer 1002.

The computer 1002 also includes a memory 1010 that can hold data for the computer 1002 or a combination of components connected to the network 1024 (whether illustrated or not). Memory 1010 can store any data consistent with the present disclosure. In some implementations, memory 1010 can be a combination of two or more different types of memory (for example, a combination of semiconductor and magnetic storage) according to particular needs, desires, or particular implementations of the computer 1002 and the described functionality. Although illustrated as a single memory 1010 in FIG. 10, two or more memories 1010 (of the same, different, or combination of types) can be used according to particular needs, desires, or particular implementations of the computer 1002 and the described functionality. While memory 1010 is illustrated as an internal component of the computer 1002, in alternative implementations, memory 1010 can be external to the computer 1002.

The application 1012 can be an algorithmic software engine providing functionality according to particular needs, desires, or particular implementations of the computer 1002 and the described functionality. For example, application 1012 can serve as one or more components, modules, or applications. Further, although illustrated as a single application 1012, the application 1012 can be implemented as multiple applications 1012 on the computer 1002. In addition, although illustrated as internal to the computer 1002, in alternative implementations, the application 1012 can be external to the computer 1002.

The computer 1002 can also include a power supply 1018. The power supply 1018 can include a rechargeable or non-rechargeable battery that can be configured to be either user- or non-user-replaceable. In some implementations, the power supply 1018 can include power-conversion and management circuits, including recharging, standby, and power management functionalities. In some implementations, the power-supply 1018 can include a power plug to allow the computer 1002 to be plugged into a wall socket or a power source to, for example, power the computer 1002 or recharge a rechargeable battery.

There can be any number of computers 1002 associated with, or external to, a computer system containing computer 1002, with each computer 1002 communicating over network 1024. Further, the terms “client,” “user,” and other appropriate terminology can be used interchangeably, as appropriate, without departing from the scope of the present disclosure. Moreover, the present disclosure contemplates that many users can use one computer 1002 and one user can use multiple computers 1002.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 1002.11 a/b/g/n or 1002.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, it will be understood that various modifications may be made without departing from the spirit and scope of the data processing system described herein. Accordingly, other embodiments are within the scope of the following claims.

What is claimed is:

1. A computer-implemented method for generating a subsurface velocity model to improve an accuracy of seismic imaging of a subterranean formation, the method comprising:
receiving for a plurality of common midpoint-offset bins each comprising a respective plurality of seismic traces, respective candidate pilot traces representing the plurality of common midpoint-offset bins;
generating, based on the respective candidate pilot traces, a respective plurality of corrected seismic traces for each of the plurality of common midpoint-offset bins;
grouping the respective pluralities of corrected seismic traces into a plurality of enhanced virtual shot gathers (eVSGs);
generating, based on the plurality of common midpoint-offset bins, a common-midpoint (CMP) velocity model;
calibrating the CMP velocity model using uphole velocity data to generate a pseudo-3 dimensional (3D) velocity model;
performing, based on the plurality of enhanced virtual shot gathers and the pseudo-3D velocity model, a 1.5-dimensional full waveform inversion (FWI); and
determining the subsurface velocity model based on the 1.5 dimensional FWI.

2. The computer-implemented method of claim 1, further comprising:
pre-processing the uphole velocity data by:
performing cubic Hermite spline fitting on the uphole velocity data to generate spline fitted velocity data;
iteratively simplifying the spline fitted velocity data using a Douglas-Peucker method; and
interpolating the simplified velocity data to generate an interval uphole velocity model.

3. The computer-implemented method of claim 1, wherein calibrating the CMP velocity model using the uphole velocity data comprises:
interpolating the uphole velocity data using a regionalized parameter distribution based on the CMP velocity model.

4. The computer-implemented method of claim 3, wherein interpolating the uphole velocity data using the regionalized parameter distribution is performed using at least one of kriging, co-kriging, or a machine learning module.

5. The computer-implemented method of claim 3, wherein interpolating the uphole velocity data is further performed using at least one of near-surface transmission residual statics or near-surface transmission amplitude residuals, wherein the near surface transmission residual statics and the near-surface transmission amplitude residuals are generated based on the respective pluralities of corrected seismic traces.

6. The computer-implemented method of claim 1, further comprising:
generating, based on the pseudo-3D velocity model, gradient-based coupling operators; and
applying the gradient-based coupling operators to constrain a 3D tomography process to generate a 3D velocity model calibrated with upholes.

7. The computer-implemented method of claim 1, wherein performing the 1.5-dimensional full waveform inversion is further based on the 3D velocity model calibrated with upholes.

8. The computer-implemented method of claim 1, further comprising:
calibrating the subsurface velocity model using a machine learning module, wherein the machine learning module is a conditional image to image mapping network, wherein the subsurface velocity model is an input to the machine learning module, and the uphole velocity and a distribution of CMP velocity are conditional inputs.

9. The computer-implemented method of claim 1, further comprising:
calibrating the subsurface velocity model using a machine learning module, wherein the machine learning module is a semisupervised Generative adversarial networks (GAN) framework.

10. One or more non-transitory computer-readable storage media coupled to one or more processors and having instructions stored thereon which, when executed by the one or more processors, cause the one or more processors to perform operations for generating a subsurface velocity model to improve an accuracy of seismic imaging of a subterranean formation, the operations comprising:
receiving for a plurality of common midpoint-offset bins each comprising a respective plurality of seismic traces, respective candidate pilot traces representing the plurality of common midpoint-offset bins;
generating, based on the respective candidate pilot traces, a respective plurality of corrected seismic traces for each of the plurality of common midpoint-offset bins;
grouping the respective pluralities of corrected seismic traces into a plurality of enhanced virtual shot gathers (eVSGs);
generating, based on the plurality of common midpoint-offset bins, a common-midpoint (CMP) velocity model;
calibrating the CMP velocity model using uphole velocity data to generate a pseudo-3 dimensional (3D) velocity model;
performing, based on the plurality of enhanced virtual shot gathers and the pseudo-3D velocity model, a 1.5-dimensional full waveform inversion (FWI); and
determining the subsurface velocity model based on the 1.5 dimensional FWI.

11. The one or more non-transitory computer-readable storage media of claim 10, the operations further comprising:
pre-processing the uphole velocity data by:
performing cubic Hermite spline fitting on the uphole velocity data to generate spline fitted velocity data;
iteratively simplifying the spline fitted velocity data using a Douglas-Peucker method; and
interpolating the simplified velocity data to generate an interval uphole velocity model.

12. The one or more non-transitory computer-readable storage media of claim 10, wherein calibrating the CMP velocity model using the uphole velocity data comprises:
interpolating the uphole velocity data using a regionalized parameter distribution based on the CMP velocity model.

13. The one or more non-transitory computer-readable storage media of claim 12, wherein interpolating the uphole velocity data using the regionalized parameter distribution is performed using at least one of kriging, co-kriging, or a machine learning module.

14. The one or more non-transitory computer-readable storage media of claim 12, wherein interpolating the uphole velocity data is further performed using at least one of near-surface transmission residual statics or near-surface transmission amplitude residuals, wherein the near surface transmission residual statics and the near-surface transmission amplitude residuals are generated based on the respective pluralities of corrected seismic traces.

15. The one or more non-transitory computer-readable storage media of claim 10, the operations further comprising:
generating, based on the pseudo-3D velocity model, gradient-based coupling operators; and
applying the gradient-based coupling operators to constrain a 3D tomography process to generate a 3D velocity model calibrated with upholes.

16. The one or more non-transitory computer-readable storage media of claim 10, wherein performing the 1.5-dimensional full waveform inversion is further based on the 3D velocity model calibrated with upholes.

17. The one or more non-transitory computer-readable storage media of claim 10, the operations further comprising:
calibrating the subsurface velocity model using a machine learning module, wherein the machine learning module is a conditional image to image mapping network, wherein the subsurface velocity model is an input to the machine learning module, and the uphole velocity and a distribution of CMP velocity are conditional inputs.

18. The one or more non-transitory computer-readable storage media of claim 10, the operations further comprising:
calibrating the subsurface velocity model using a machine learning module, wherein the machine learning module is a semisupervised Generative adversarial networks (GAN) framework.

19. A system comprising:
one or more processors configured to perform operations comprising:
receiving for a plurality of common midpoint-offset bins each comprising a respective plurality of seismic traces, respective candidate pilot traces representing the plurality of common midpoint-offset bins;
generating, based on the respective candidate pilot traces, a respective plurality of corrected seismic traces for each of the plurality of common midpoint-offset bins;
grouping the respective pluralities of corrected seismic traces into a plurality of enhanced virtual shot gathers (eVSGs);
generating, based on the plurality of common midpoint-offset bins, a common-midpoint (CMP) velocity model;
calibrating the CMP velocity model using uphole velocity data to generate a pseudo-3 dimensional (3D) velocity model;
performing, based on the plurality of enhanced virtual shot gathers and the pseudo-3D velocity model, a 1.5-dimensional full waveform inversion (FWI); and
determining the subsurface velocity model based on the 1.5 dimensional FWI.

20. The system of claim 19, the operations further comprising:
pre-processing the uphole velocity data by:
performing cubic Hermite spline fitting on the uphole velocity data to generate spline fitted velocity data;
iteratively simplifying the spline fitted velocity data using a Douglas-Peucker method; and
interpolating the simplified velocity data to generate an interval uphole velocity model.
